(19) United States
(12) Patent Application Publication
(10) Pub. No.: US 2020/0259219 A1
(43) Pub. Date: Aug. 13, 2020

(54) COMBINED POWER STORAGE SYSTEM, AND MANAGEMENT SYSTEM THEREFOR

(71) Applicants: Felice ESTERMANN, Weggis (CH); Remo ESTERMANN, Weggis (CH); Andres STADTMANN, Weggis (CH); Daniel Amrein, Weggis (CH)

(72) Inventors: Felice ESTERMANN, Weggis (CH); Remo ESTERMANN, Weggis (CH); Andres STADTMANN, Weggis (CH)

(21) Appl. No.: 16/348,168

(22) PCT Filed: Aug. 11, 2017
(86) PCT No.: PCT/IB2017/056976

§ 371 Date: Oct. 30, 2019

(30) Foreign Application Priority Data
Nov. 9, 2016 (DE) 10 2016 013 251.5

(51) Int. Cl. H01M 10/42; H02J 7/00; H02J 7/34

(52) U.S. Cl. CPC H01M 10/4264; H02J 7/0019; H01M 10/486; H01M 2010/4271; H02J 7/345

(57) ABSTRACT

The invention relates to a combined. power storage system. (100a), comprising an accumulator storage unit (1a) having at least one rechargeable accumulator cell (2a-2f) and comprising a capacitor storage unit: (3a) having at least one capacitor (4a-4f), wherein the accumulator storage unit (1a) and. the capacitor storage unit (3a) are connected in parallel with each other and wherein both the accumulator storage unit (1a) and the capacitor storage unit (3a) can be controlled at the same time by means of a common management system (9a-9c).

The present invention concerns a power storage system comprising at least one electrochemical storage unit or at least one rechargeable accumulator and at least one capacitor storage unit. Furthermore, the invention concerns a management system for the combined accumulator-capacitor storage system and a method for balancing the accumulator cells and capacitors.

Electrochemical storage units such as rechargeable batteries, or rather battery packs, are subject to limiting factors or disadvantages such as relative moderate or good specific power density, at limited lifetime and at relative moderate charging efficiencies, i.e., a partial loss of the energy used for charging into released heat, due to the internal resistance of the cells. And further disadvantageously, the internal resistances of the cells increase additionally or the charging efficiency additionally decreases, if one charges quickly with high currents or demands high power peaks, the latter is described with the so-called Peukert effect or the rate-capacity effect.

The dependency on temperature and aging processes, as well as self-discharge, are also limiting or disadvantageous factors for electrochemical storage units.

It is also disadvantageous if the life of the electrochemical storage units is limited by their cycle stability and if the charging times are relatively long, at least to achieve full charging. Besides, rechargeable batteries always require charging control.

Capacitor storage units within the meaning of this invention, however, such as capacitors or super-capacitors with fixed capacitance values, or variable capacitors with adjustable capacitance values, are suitable for storing electrical charges and the associated energy, unlike electrochemical storage units, because of their low internal resistance, in particular for high power consumption or output, in a more limited time frame. Within the scope of the disclosure of the present application, all common types of solid capacitors should be included, i.e., electrostatic capacitors such as vacuum, air, mica, glass, silicon, ceramic, plastic film or paper capacitors, as well as electrolytic capacitors and electrochemical (super-) capacitors such as double layer, pseudo and hybrid capacitors. However, variable rotary or trimmer capacitors should also be within the scope of the disclosure of the present application.

In general, the advantages of capacitors over rechargeable battery packs are their high power density with high peak current carrying capacity, significantly greater cycle stability, short charging times, maintenance-free operation and long service life. In comparison, the higher price, the lower energy density, a high self-discharge rate and the fact that capacitors always require power electronics are disadvantageous for certain capacitor types.

There are accumulator systems that combine rechargeable batteries with capacitors and seek to compensate the disadvantages of one type of accumulator with the advantages of the other. Essentially, the aim is to combine the advantages of the relatively high energy density of accumulators with the high power density of capacitors, super caps or ultra caps.

However, generally speaking, the rated voltage of capacitors is limited to a relative low value which is usually below the value of the required operating voltage of the employment. This means that such power storage systems combined with capacitors usually cannot do without series connections of several capacitors, in which the individual partial voltages add up. The capacitor with the smallest capacitance receives the largest partial voltage. In the case of DC voltage, the series connection of several capacitors of the same type requires voltage balancing by means of resistors connected in parallel, because otherwise the capacitor with the smallest random capacitance receives the highest (possibly destructively high) voltage. Since each capacitor basically has small differences in its characteristics compared to the other capacitors, e.g., in the ESR value (equivalent series resistance or internal loss resistance), it is necessary to balance the capacitors by means of passive balancing—as mentioned above, for example with resistors—or by means of active balancing with an electronic control circuit.

The technical problem of the present invention is to provide a new combined accumulator/capacitor power storage system and a management system for it that is generally optimized in its characteristics, its application and its life, while avoiding the above disadvantages. In particular, power consumption and output should be improved, while at the same time protecting the accumulator cells.

The solution of the technical problem is in the first instance in designing and arranging a combined power storage system in which an accumulator storage unit or an accumulator module comprises at least one rechargeable accumulator cell and—arranged in parallel thereto—a capacitor storage unit or a capacitor module with at least one capacitor. This combined power storage system further includes at least a common management system that controls both the accumulator storage unit and the capacitor storage unit, simultaneously.

According to a preferred embodiment version of a combined power storage system according to the invention, at least two accumulator cells connected in series form the accumulator storage unit and at least two capacitors connected in series form the capacitor storage unit. The accumulator storage unit and the capacitor storage unit, however, remain arranged in parallel to each other.

The inventive common management system of an inventive combined power storage system may include separate sub-management systems, at least one for the accumulator storage unit and at least one for the capacitor storage unit. In any case, these sub-management systems remain connected to the common accumulator-capacitor management system according to the invention, which can ultimately and in accordance with the invention always control both storage units, together.

Furthermore, a combined power storage system according to the invention is characterized by the fact that the common management system can control and balance or equalize both the individual accumulator cells and the individual capacitors together. This management system, which in itself is an invention, can therefore no longer be described as a battery management system (BMS), but perhaps as an accumulator-capacitor management system.

Such a management system, according to the invention, is on the one hand an active management system, i.e., a charge surplus of a cell is not passively converted into heat, but the balancing or equalization between the individual accumulator cells or/and the individual capacitors is performed actively by means of a balancing current. This results in barely any energy losses and barely any heat development, which in turn would require cooling or ventilation.

The balancing or boost currents of a management system according to the invention, are decoupled from a total uniform charging current of an external charging source and can still be controlled according to the invention by means of a separate microcontroller or a microcontroller integrated into the management system, specifically per accumulator cell or capacitor. Conventionally, there is a single, total charge current that charges all cells equally, without differentiation. As soon as, for example, a charge energy of 90% is reached in a cell, the charge current is greatly reduced in known active management systems and the energy is transported from the cell with the maximum voltage to the weakest cell by rearrangement from cell to cell. Among other things, this rearrangement leads to restlessness in the storage system and the balancing process takes a long time.

A management system according to the invention is designed to form a potential-free, so-called “virtual” power source within the system, which is a power source for balancing, independent of an external charging source and also independent of the respective operating state of the combined power storage system. The current of this virtual power source can furthermore according to the invention be “divided” or switched into individually assignable boost currents for each accumulator cell or capacitor by means of individually controllable switches, preferably electronic ones. By this any accumulator cell can be controlled individually or any capacitor individually and selectively, regardless of its or its operating state or the SoC (State of Charge) or the SoH (State of Health).

According to the invention, the management system is levelable or balanceable also by the described virtual power source and the described single switches upwards, not as usual downwards. In other words, one could describe the inventive management system as progressive and not degressive, because not the stronger cells are downgraded to a lower store level, but the weaker ones up to the store level of the stronger ones.

It may also be provided that the microcontroller and switch-controlled allocation of the boost currents can be carried out both as described above by means of a current drawn from the virtual power source and by means of a current from an external power source, as well as by means of a current from a subsystem of a multiple combined power storage system according to the invention.

That is to say it is furthermore possible to provide connections so that a first combined power storage system according to the invention in the form of a subsystem can be interconnected with at least a second power storage system according to the invention in the form of a further subsystem, either in series or in parallel, as desired.

An algorithm for determining the optimum distribution of boost currents is preferably stored in the microcontroller. In this algorithm it is preferably defined how the respective state of the respective accumulator cell or capacitor can be determined and on the basis of which sensor data. The algorithm also defines that more and/or longer time intervals and/or possibly higher boost currents can be allocated to the weakest accumulator cells or capacitors or subsystems determined. To the “strongest” accumulator cells or capacitors or subsystems, may not be assigned any boost currents.

The algorithm can also provide that the amount of boost currents can be variable, e.g. depending on SoC and/or SoH and/or on the number of cells requiring a boost current and/or on the prevailing charge difference.

The algorithm also preferably defines threshold values that define a “working window” for boosting, i.e., from which charge differences as well as up to which charge differences the balancing is performed. The upper threshold value is intended to prevent that unnecessarily energy-consuming balancing is still taking place at a charge difference level that is already tolerable or even irrelevant low. The lower threshold value is intended to prevent that a completely or excessively discharged cell is incorporated into boosting instead of being replaced.

The microcontroller or the stored algorithm are designed in such a way that dynamic balancing takes place. The desired balanced status can be sometimes higher or sometimes lower. The duration of the balancing and the protection of the cells should be decisive. It has been recognized that a good balanced state can be reached earlier than simultaneously boosting all weak cells to a highest charge level, just like conventional battery management systems do.

Furthermore, the microcontroller and the stored algorithm are designed so that boost sequences or hierarchies are predefined. For example, first is balanced the weakest subsystem or subsystems, and only then the entire system.

The aim of all these measures is to create an intelligent control system that avoids unnecessary balancing processes while at the same time saving time and protecting cells as much as possible.

Furthermore, an inventive accumulator-capacitor management system, supported by the described components single switch and virtual power source, as well as through the microcontroller, is able to function at any operating state of the power storage system. The balancing or equalization of the individual accumulator cells or/and capacitors or/and subsystems can take place not only during a charging process, but also under load during discharge, as well as in idle mode.

A first indicator for determining which accumulator cells, capacitors or subsystems are to be boosted at all, is the so-called SoC (State of Charge) or charge level of a particular accumulator cell or capacitor or subsystem. According to the invention, this SoC can be displayed not only during a charging process, but also during discharge or in an idle mode of a combined power storage system according to the invention. A second indicator is the so-called SoH (State of Health) of a particular accumulator cell or capacitor or subsystem. These two indicators usually include the measurement and testing of voltage, temperature and internal resistance. Chemical and pressure sensor measurements can also be used to determine the SoC and SoH.

According to the invention, the microcontroller is also designed in such a way that it can record another indicator, namely the number of boosts per time-interval. The device for this shall be called Boost Counter. In this patent application, “boost” refers to the charge current that can be controlled individually for each accumulator cell, capacitor or subsystem. By automatically allocating the required charging or equalizing current for the respective accumulator cell or capacitor or subsystem whenever necessary by an accumulator-capacitor management system in accordance with the invention, a recording or counting of the boosts results gives a direct indication of the capacity of the respective accumulator cell or the relevant capacitor or subsystem, as well under load and during charging, and as well in neither of the two modes, i.e., in an idle mode. The boost interventions per time show which accumulator cells or capacitors or subsystems have the worst internal resistance behavior when charging or under load. On the other hand, they show which accumulator cells or capacitors or subsystems have the highest self-discharge rates, if not under load. In this way, a further indicator is introduced in accordance with the invention, with the help of which the condition of the individual accumulator cells or capacitors or subsystems can be recorded more accurately than before, thus further improving the balancing or equalization. The evaluation of these boost counter data can also contribute to the early detection of possible failures.

In order to be able to switch on and off the two storage units of a combined power storage system according to the invention as required, but also in order to be able to react for safety reasons to unforeseen operating modes such as an excessive current, both storage units preferably have at least one switching contact each, which is/are furthermore preferably switchable with at least one coil each.

Optionally, an electronically controllable resistor is arranged at the input of the storage units or preferably at least at the input of the capacitor storage unit. On the one hand, this resistor serves the purpose of damping the power output or consumption. On the other hand, this electronically controllable resistor can be used to control the energy flow in the overall system of the inventive combined power storage device in the sense that it enables the relationship between accumulator current and capacitor current to be influenced. A further, optional function of this electronically controllable resistor is to protect the system through a temporary increasing in resistance, for example when it is switched on, or generally at very different voltages between the accumulator storage unit and the capacitor storage unit.

Furthermore, optionally, instead of—or in addition to the electronically controllable resistor described above, a voltage matching circuit can be arranged, which comprises at least one coil and at least two switch contacts controllable by it.

The microcontroller should preferably be equipped with software which, together with appropriate hardware, makes it possible to carry out self-tests or plausibility checks on the displayed actual states and the recorded or the measured values.

A combined power storage system according to the invention preferably includes at least one current sensor as a signal generator for the microcontroller of the accumulator-capacitor management system for automatic switch-off or load limitation. The current sensor is also important for determining the SoC and SoH.

Furthermore, an inventive accumulator-capacitor management system preferably includes an alarm output interface, for example for the output of an optical and/or acoustic alarm signal or for the sending of an SMS or a message to the server or other higher-level systems.

A combined power storage system according to the invention preferably has a display to show the processes taking place, but also at least one communication module for external communication, preferably bidirectional. This can be a serial, parallel or TCPIP- or Ethernet- or WLAN- or ELDAT-communication module or radio or Bluetooth or ZIGBee or KNX or CAN bus or Token Ring based interface or combinations thereof. A GSM module can be used to send SMS messages. For mobile applications, for example in an electric car, a GPS module can be arranged.

Communication as described above is preferably encrypted and signed.

Furthermore, an inventive accumulator-capacitor management system includes the user input interface for an integrated or external display with input capability. This user input interface preferably also provides a remote control, but also the possibility of remote maintenance via an IP address or/and a server.

A combined power storage system according to the invention may, in addition to a cooling and/or ventilation device for the power storage system itself, optionally include a cooling device for the charging cable(s) and for the cables and connections to which it is connected to the load or to an external power source. It was found that the power consumption for adequate cooling could be lower than the losses of the connection resistors.

Furthermore, a combined power storage system according to the invention is preferably designed as a modular rack or frame with profile rails and can thus be adjusted at will to any sizes or outputs.

Optionally, the rack can be designed as a housing, preferably a system protected against contact, foreign objects and moisture. The IP degree of protection can range from IP21XX to IP68DH, depending on the application of the combined power storage system, for example even as a propulsion unit for watercraft. The selected degree of protection lies within this range, preferably at IP53XX, in order to satisfy ex factory the most areas of application.

A combined power storage system according to the invention preferably has a so-called non-volatile safety memory for the system data. In addition, this system data is preferably transmitted to a server via the interfaces described above.

The voltage supply of the control of a combined power storage system according to the invention is preferably 12 volts. The insulation voltage is preferably 400 volts.

A print, i.e., an accumulator or capacitor storage unit, is designed to preferably comprise eight individual accumulator cells, connected in series or eight individual capacitors arranged in series.

An inventive power storage system is characterized by a certain ratio selected between the nominal capacity of the accumulator storage unit in watt-hours and the nominal capacity of the capacitor storage unit, also in watt-hours. This ratio between accumulator and capacitor capacity ranges from 1:1 to 1:200 and is preferably close to 1:80, because it has been found that at this ratio the accumulator storage unit is optimally buffered by the capacitor storage unit, with an average peak power reduction of around 60% over 6 seconds, at a load of 1 C and an ambient temperature of 20 degrees Celsius.

Depending on the field of application, e.g. stationary or mobile, and depending on the requirement profile, this ratio may vary within the specified range according to the invention.

For reasons of redundancy, in a combined power storage system according to the invention, it may be intended that the voltage or other values are measured not only with one measurement method, but with two different measurement methods.

The focus of the technological approach of the present invention is mainly, in contrast to the known concepts, where capacitors used as extremely fast-charging traction accumulators are in the main focus, the reduction of load peaks and thus protecting the accumulator cells, while at the same time significantly increasing the performance of the overall system.

A physical conditioned law also increases the effectiveness of the technology approach. This means that as the load current increases, the depth of discharge and thus the usable capacitance of the capacitors increases, i.e. just when they are needed the most. Because the greater the voltage difference between the voltage levels with load is, the more energy can be released by capacitors connected in parallel. This means that unfavorable developments, such as aging processes and unfavorable environmental situations, such as cold, which are associated with a reduction in voltage stability, can be compensated to a certain extent.

The disclosed different embodiment versions of a combined power storage system according to the invention are combinable with each other at will, with regard to the features not relevant to basic functions. For example, both basic embodiment versions of a combined power storage system according to the invention, i.e., the minimal embodiment version with only one accumulator cell and only one capacitor or the preferred embodiment version with multiple accumulator cells and multiple capacitors, are in equal measure combinable with the described management systems, regardless whether it is a single combined management system or one with separate sub-management systems for the accumulator storage unit and capacitor storage unit. The same applies to the subsystems of a multi-system combined power storage system according to the invention. These subsystems do not have to be identical. All the embodiment versions resulting therefrom are similarly and reciprocally, individually and collectively, combinable with the features listed in the paragraphs [0014] to [0041].

The present application discloses a procedure for joint equalization or mutual balancing of individual accumulator cells of an accumulator storage unit and individual capacitors of a capacitor storage unit, whether these are each separately on their own self-sufficient systems or whether they are components of a combined power storage system as disclosed, by carrying out the following basic procedural steps:

a) sensory gathering the voltage, current, temperature and time data of all accumulator cells or/and all capacitors;

b) gathering the boost counter data of the accumulator cells or/and the capacitors, in their number and in their current strength, during charging and/or discharging and/or in the idle mode, and/or within the whole life and/or in several specific time intervals;

c) evaluating all the gathered data and calculating the SoC of each accumulator cell or/and capacitor;

d) calculating the SoH of each accumulator cell or/and capacitor;

e) evaluating the SoC and the SoH and determining the accumulator cells or/and capacitors to be boosted;

f) assigning the boost currents by means of the individual switches and controlling the potential-free power source.

A combined power storage system according to the invention offers the following advantages:

It combines the advantages of accumulators with those of capacitors.

The power peaks, harmful to the accumulator cells are buffered by the capacitors.

The power output and consumption are increased.

The cycle strength of the accumulator cells is increased.

The service life of the accumulator cells is increased.

The inventive power storage system has a common management system that controls both the accumulator cells and the capacitors simultaneously.

The management system or rather the balancing or equalizing of the individual accumulator cells and capacitors works at every operating stage of the power storage system.

The equalizing currents are decoupled from a single common charging power of an external charging source and can be assigned individually to each accumulator cell and capacitor.

Active balancing takes place faster and with less energy loss than passive balancing.

Heat generation and cooling or ventilation requirements are low.

Further or advantageous embodiments of a combined power storage system according to the invention form the subject matter of the dependent claims.

The reference list is part of the disclosure.

The invention will be symbolically and exemplarily explained in more detail, with reference to figures. The figures are described coherently and comprehensively. They represent schematic and exemplary representations and are not to scale, even not in the relation between individual components. Same reference signs indicate the same component; reference signs with different indices indicate identical or similar components.
It is shown thereby

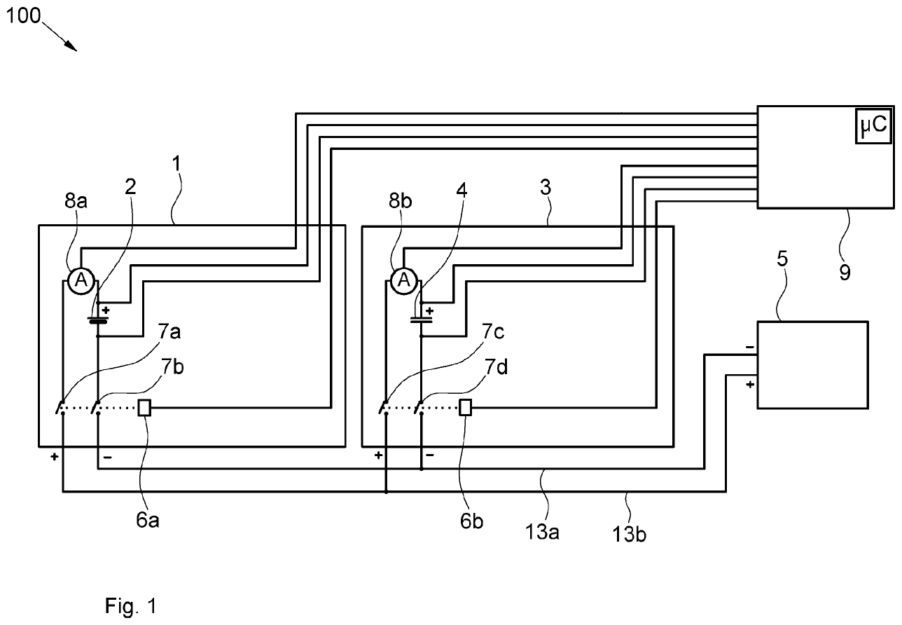

FIG. 1 a symbolic and exemplary scheme of a minimal version of a combined power storage system according to the invention, with an accumulator storage unit comprising an accumulator cell and a thereto parallel connected capacitor storage unit, comprising a capacitor;

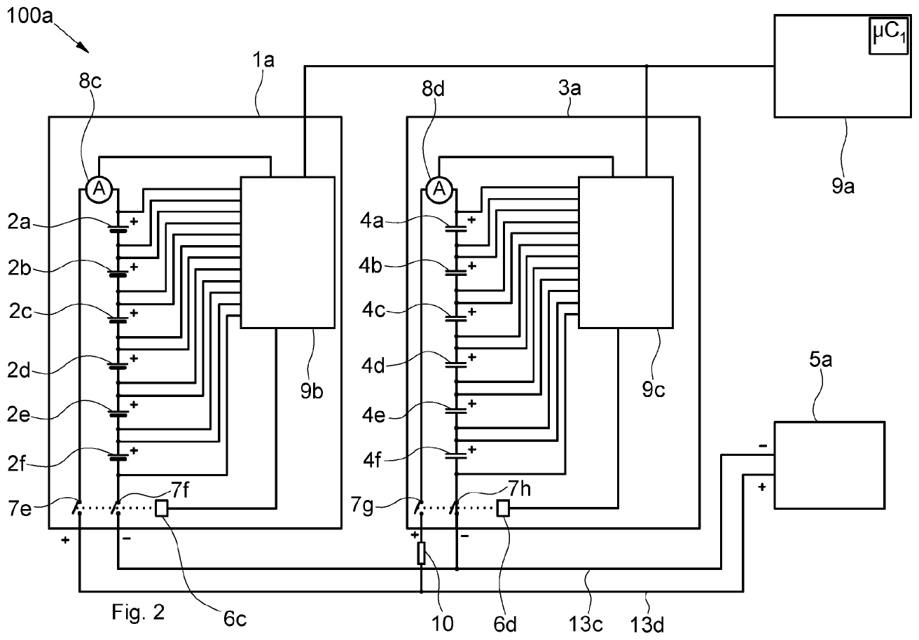

FIG. 2 a symbolic and exemplary scheme of a preferred embodiment version of an inventive combined power storage system comprising an accumulator storage unit comprising multiple series-connected accumulator cells and a therewith parallel connected capacitor storage unit comprising multiple series-connected capacitors;

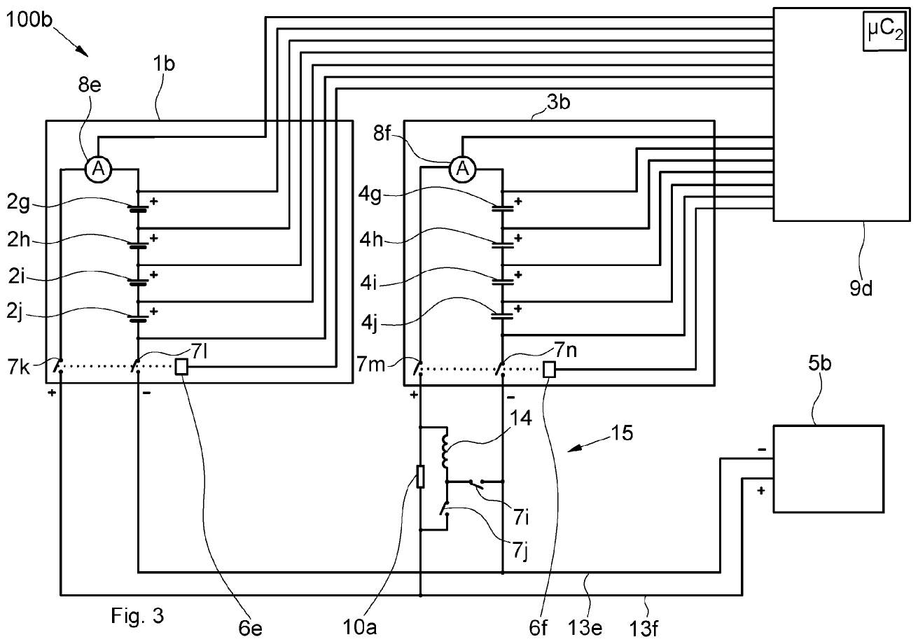

FIG. 3 a symbolic and exemplary scheme of a further preferred embodiment version of an inventive combined power storage system with an accumulator storage unit also comprising multiple series-connected accumulator cells and with a capacitor storage unit connected in parallel therewith also comprising multiple series-connected capacitors, all in a slightly modified basic circuit with a coil;

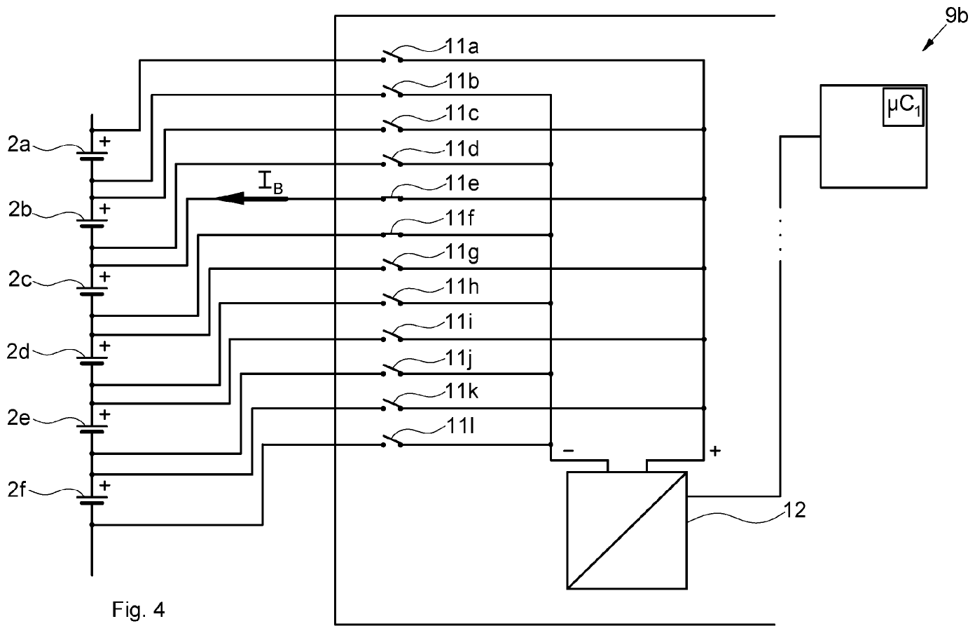

FIG. 4 a symbolic and exemplary scheme of an inventive accumulator sub-management system;

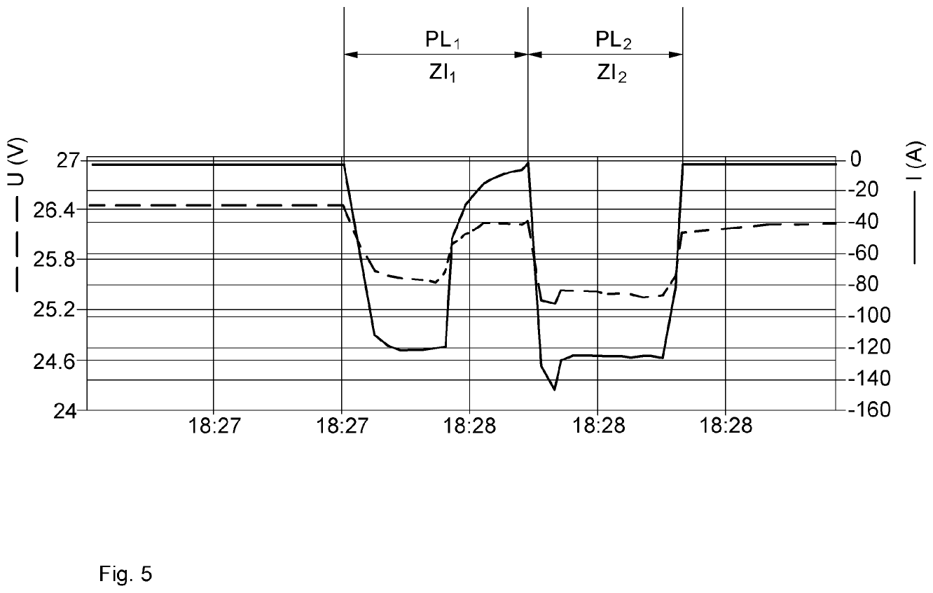

FIG. 5 a symbolic and exemplary diagram, showing the voltage curve and current intensity curve under one pulse load each, once with a capacitor support and comparatively, once without, and

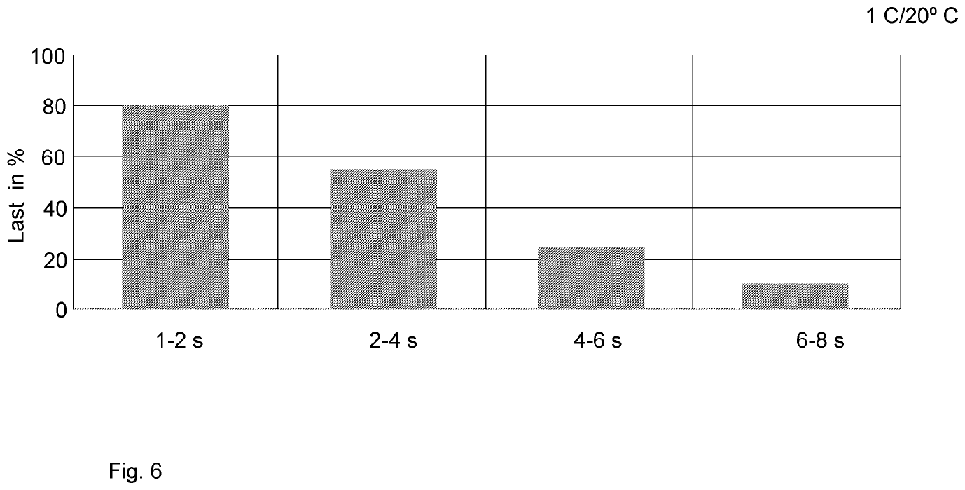

FIG. 6 a symbolic and exemplary diagram of the reduction of power peaks along a time axis.

FIG. 1 shows in a symbolic and exemplary scheme a first embodiment version of a combined power storage system 100 according to the invention, which corresponds to a minimal version insofar as there is essentially only one accumulator storage unit 1 with one accumulator cell 2, as well as a capacitor storage unit 3 with a capacitor 4, and a common accumulator capacitor management system 9. The latter comprises a microcontroller μC.

The accumulator storage unit 1 is connected to a load or external power source 5 by means of a negative wire 13a and a positive wire 13b and the capacitor storage unit 3 also, anyhow however in parallel to each other. The accumulator storage unit 1 comprises a switch contact 7a respectively 7b, each at the input of both the negative and positive wire, both of them controllable by means of a coil 6a. The accumulator storage unit 1 further comprises a current sensor 8a, as a signal transmitter to the accumulator capacitor management system 9 for an automatic switch-off of the accumulator storage unit 1 by means of the coil 6a and the switching contacts 7a and/or 7b.

The capacitor storage unit 3 has a similar composition, with a current sensor 8b and switch contacts 7c and 7d, controlled by a coil 6b. Especially in the case of the capacitor storage unit 3, the switch contacts 7c and 7d can still be used for switching off during longer rest periods, because the capacitor 4 is subject to a higher self-discharge rate than the accumulator cell 2.

FIG. 2 shows in a symbolic circuit diagram a combined power storage system 100a, which is still in accordance with the invention. Again, an accumulator storage unit 1a and a capacitor storage unit 3a are connected in parallel to a load or external power source 5a by means of a negative wire 13c and a positive wire 13d.

The accumulator storage unit 1a comprises any number of accumulator cells 2a-2f connected in series, which in turn are, for a better understanding, connected to a sub-management system 9b with two separate wires.

Where wires 13c and 13d enter the accumulator storage unit 1a, switch contacts 7e and 7f are arranged respectively, both of which actuated by a coil 6c.

Furthermore, the accumulator storage unit 1a includes a current sensor 8c, as a signal transmitter to the part management system 9b, for automatically switching off the accumulator storage unit 1a by means of the coil 6c and the switching contacts 7e and/or 7f.

The capacitor storage unit 3a is constructed analogously to the accumulator storage unit 1a, with any number of capacitors 4a-4f arranged in series, a current sensor 8d connected to a partial management system 9c. The latter can control a coil 6d to close the switch contacts 7g and 7h.

The number of accumulator cells 2a-2f and capacitors 4a-4f needs not be identical.

Optionally, thus also possible with the minimal version of a combined power storage system 100 from FIG. 1, a further preferably electronically controlled resistor 10 is arranged in series, preferably connected to the positive wire 13d input, to the capacitor storage unit 3a.

The two sub-management systems 9b and 9c are connected in parallel to a common accumulator-capacitor management system 9a, quasi as sub-systems or slaves with a master. A microcontroller μC₁ is shown as part of the master, but slaves 9b and 9c can also be included or added.

FIG. 3 shows a further preferred embodiment version according to the invention, of a combined power storage system 100b, comprising essentially an accumulator storage unit 1b, a capacitor storage unit 3b, and a common accumulator-capacitor management system 9d with a microcontroller μC₂. The accumulator storage unit 1b and the capacitor storage unit 3b are connected in parallel with a load or external power source 5b, by means of wires 13e and 13f. Input of these wires 13e and 13f into the accumulator storage unit 1b, are again preferably provided at both wires switch contacts 7k and 7l, which are switchable by means of a coil 6e. A similar arrangement is provided for the capacitor storage unit 3b, with switch contacts 7m and 7n and a coil 6f.

As per the previous embodiment versions, both the accumulator storage unit 1b and the capacitor storage unit 3b, each comprise a current sensor 8e respectively 8f.

A resistor 10a, which is preferably electronically controllable, is again arranged on the positive wire 13f and bridged by a coil 14. This bridging is connected with a switch contact 7i to the negative wire 13e and with a further switch contact 7j, the bridging itself can be interrupted or closed. Preferably electronic switches are used for 7i and 7j.

FIG. 4 shows schematically and representative for all management systems according to the invention of the present application, the structure of the accumulator sub-management system 9b from FIG. 2. It comprises a potential-free and/or virtual power source 12, of which, symbolically triggered as from the common accumulator-capacitor management system 9a, a boost current I_{B} is currently assigned to an accumulator cell 2c, due to closed single switches 11e and 11f. Further preferably electronic single switches 11a-11d and 11g-11l, are open and therefore further accumulator cells 2a, 2b, 2d-2f are currently not assigned to a boost current

FIG. 5 shows the voltage curve with a dotted line and the amperage curve of a combined power storage system according to the invention, along a time axis with a solid line. A first time interval ZI₁ shows a first pulse load PL₁ and a second time interval ZI₂ shows a second pulse load PL₂. The first pulse load PL₁ was with capacitor support and the second without. The curves for pulse load PL₂ are less steep and abrupt and the drop is not as deep as for pulse load PL₂. The power output is buffered by the capacitors. This results in an improved power output while, at the same time, protecting the accumulator cells.

FIG. 6 shows by means of a diagram, that under ambient conditions of 20 degrees Celsius and a load of 1 C, the load peaks are reduced by 80 percent within the first 2 seconds, by 55 percent within the next 2 seconds, by 25 percent within the next 2 seconds and by 10 percent within the next 2 seconds with a combined power storage system according to the invention.

### REFERENCE LIST

1, 1a, 1b—accumulator storage storage unit
2, 2a-2j—accumulator cell
3, 3a, 3b—capacitor storage unit
4, 4a-4j—capacitor, super-capacitor, ultra-capacitor, super-capacitor, ultra-capacitor, double layer, pseudo or hybrid capacitor
5, 5a, 5b—load or external power source
6a-6f—coil
7a-7n—switch contact
8a-8f—current sensor
9, 9a-9d—accumulators-capacitors management system, management system, part management system
10, 10a—electronically controllable resistor
11a-11l—single switch, electronic switch
12—potential-free power source, virtual power source
13a-13f—wire
14—coil
15—voltage matching circuit
100, 100a, 100b—combined power storage system, accumulator-capacitor storage system

I_{B}—boost current
μC, μC₁, μC₂—microcontroller
PI₁, PL₂—pulse load
ZI₁, ZI₂—time interval

1. Power storage system (100, 100a, 100b), comprising an accumulator storage unit (1, 1a, 1b) with at least one rechargeable accumulator cell (2, 2a-2j) and a capacitor storage unit (3, 3a, 3b) with at least one capacitor (4, 4a-4j), characterized in that the accumulator storage unit (1, 1a, 1b) and the capacitor storage unit (3, 3a, 3b) are connected in such way in parallel with each other, that a positive and a negative connection of a load or an external power source (5, 5a, 5b) are directly connectable as well to the accumulator storage unit (1, 1a, 1b) as to the capacitor storage unit (3, 3a, 3b) by means of direct wires (13a-13f) with switch contacts (7a-7n) and that as well the accumulator storage unit (1, 1a, 1b) as the capacitor storage unit (3, 3a, 3b) are simultaneously controllable, by means of a common accumulator-capacitor management system (9, 9a-9d) and that the accumulator-capacitor management system (9, 9a-9d) comprises at least one microcontroller (μC, μC₁, μC₂) with which, a potential-free, virtual power source (12) and individual switches (11a-11lare controllable in such way, that at least one boost current (I_{B}) is assignable to any accumulator cell (2, 2a-2j) and/or any capacitor (4, 4a-4j).

2. Power storage system (100, 100a, 100b) according to claim 1, characterized in that the accumulator-capacitor management system (9a) comprises systems (9b, 9c). at least one first partial management system (9b) for the accumulator cells (2, 2a-2j) and at least a second partial management system (9c) for the capacitors (4, 4a-4j).

3. (canceled)

4. Power storage system (100, 100a, 100b) according to claim 1, characterized in that the power storage system (100, 100a, 100b) has connections by means of which it is combinable with further power storage systems (100, 100a, 100b).

5. Power storage system (100, 100a, 100b) claim 4 characterized in that an algorithm is stored in the microcontroller (μC, μC₁, μC₂) which defines the boost currents (I_{B}) variably and dynamically.

6. Power storage system (100, 100a, 100b) according to claim 4, characterized in that the microcontroller (μC, μC₁, μC₂) comprises a boost counter which counts the boosts.

7. Power storage system (100, 100a, 100b) according to claim 4, characterized in that an algorithm is stored in the microcontroller (μC, μC₁, μC₂), which defines a lower threshold value, from which charge differences between the accumulator cells (2, 2a-2j) and/or the capacitors (4, 4a-4j) will be boosted, and defines an upper threshold value, up to which charge differences between the accumulator cells (2, 2a-2j) and/or the capacitors (4, 4a-4j) will be boosted.

8. Power storage system (100, 100a, 100b) according to claim 4, characterized in that an algorithm is stored in the microcontroller (μC, μC₁, μC₂), and that the algorithm defines boost sequences, so that the weakest subsystem or subsystems are balanceable and only then the entire system.

9. Power storage system (100, 100a, 100b) according to claim 1, characterized in that an electronically controllable resistor (10, 10a) is arranged at least at the capacitor storage unit (3, 3a, 3b).

10. Power storage system (100, 100a, 100b) claim 1, characterized in that a voltage matching circuit (15) is arranged at least at the capacitor storage unit (3, 3a, 3b) and that the voltage matching circuit (15) comprises at least one coil (14) and at least two controllable switch contacts (7i, 7j).

11. Power storage system (100, 100a, 100b) according to claim 4, characterized in that the microcontroller (μC, μC₁, μC₂) comprises software and the power storage system (100, 100a, 100b) comprises hardware by means of which self-tests or plausibility checks of the displayed actual states and of the detected or measured values are feasible.

12. Power storage system (100, 100a, 100b) according to claim 1, characterized in that the accumulator storage unit (1, 1a, 1b) and the capacitor storage unit (3, 3a, 3b), each comprise at least one current sensor (8a-8f).

13. Power storage system (100, 100a, 100b) according to claim 1, characterized in that the power storage system (100, 100a, 100b) comprises an alarm output interface.

14. Power storage system (100, 100a, 100b) according to claim 1, characterized in that the storage system (100, 100a, 100b) comprises an user input interface for a remote control and/or for a remote maintenance.

15. Power storage system (100, 100a, 100b) according to claim 1, characterized in that the power storage system (100, 100a, 100b) comprises at least one communication module that communicates bidirectionally and encrypted.

16. Power storage system (100, 100a, 100b) according to claim 1, characterized in that the power storage system (100, 100a, 100b) comprises a cooling device for the charging cable and the cables and connections of the power storage system (100, 100a, 100b).

17. Power storage system (100, 100a, 100b) according to claim 1, characterized in that the power storage system (100, 100a, 100b) is arrangeable in a rack which is modularly constructed and scalable.

18. Power storage system (100, 100a, 100b) according to claim 17, characterized in that the rack is designed as a housing whose IP protection lies in a range from IP21XX to IP68DH and is preferably IP53XX.

19. Power storage system (100, 100a, 100b) according to claim 1, characterized in that there is a ratio between the nominal capacity of the accumulator storage unit (1, 1a, 1b) and the nominal capacity of the capacitor storage unit (3, 3a, 3b) which is in a range from 1:1 to 1:200 and preferably is 1:80.

20. Procedure for balancing different charging states of accumulator cells among each other in a separate accumulator storage unit, or of capacitors among each other in a separate capacitor storage unit, or of accumulator cells (2, 2a-2j) and capacitors (4, 4a-4j) in a combined accumulator-capacitor power storage system (100, 100a, 100b) with a microcontroller (μC, μC₁, μC₂), which controls a potential-free power source (12) as well as individual switches (11a-11l) according to claim 5, characterized in that the following basic procedure steps are carried out:
a)—sensory gathering of the data relating to the voltage, current strength, temperature and time of all the accumulator cells (2, 2a-2j) or/and of all the capacitors (4, 4a-4j);
b)—gathering of the boost counter data of the accumulator cells (2, 2a-2j) or/and of the capacitors (4, 4a-4j), in their number and in their current strength, during charging and/or during discharging and/or in the idle mode, and/or within the whole life and/or in several specific time intervals;
c)—evaluating all the gathered data and calculating the SoC of each accumulator cell (2, 2a-2j) or/and each capacitor (4, 4a-4j);
d)—calculating the SoH of each accumulator cell (2, 2a-2j) or/and each capacitor (4, 4a-4j);
e)—evaluating the SoC and the SoH and determining the accumulator cells (2, 2a-2j) or/and capacitors (4, 4a-4j) to be boosted;
f)—assigning the boost currents (I_{B}) by means of the individual switches (11a-11l) and of the control of the potential-free power source (12).
